(19) United States
(12) Patent Application Publication
(10) Pub. No.: US 2021/0142293 A1
(43) Pub. Date: May 13, 2021

(54) FEEDBACK-BASED UPDATE OF CANDIDATE RECOMMENDATIONS

(71) Applicant: Microsoft Technology Licensing, LLC, Redmond, WA (US)

(72) Inventors: Krishnaram Kenthapadi, Sunnyvale, CA (US); Cagri Ozcaglar, Sunnyvale, CA (US)

(73) Assignee: Microsoft Technology Licensing, LLC, Redmond, WA (US)

(21) Appl. No.: 16/682,968

(22) Filed: Nov. 13, 2019

(51) Int. Cl. G06Q 10/10; G06F 16/9535; G06F 16/20; G06F 16/9538; G06F 16/21; G06F 16/28

(52) U.S. Cl. CPC G06Q 10/1053; G06F 16/9535; G06F 16/285; G06F 16/9538; G06F 16/212; G06F 16/20

(57) ABSTRACT

The disclosed embodiments provide a system for processing data. The system obtains, based on parameters of a search by an entity, a first set of scores representing significances of a set of attributes as qualifications for an opportunity. Next, the system generates a ranking of candidates for the opportunity based on the first set of scores and additional sets of scores representing confidences in possession of the attributes by the candidates. The system outputs the ranking as results of the search during a session with the entity. The system updates the first set of scores based on one or more actions by the entity on one or more candidates in the outputted ranking and one or more additional sets of scores for the candidate(s). Finally, the system updates the outputted ranking based on the updated first set of scores and the additional sets of scores during the session.

### BACKGROUND

### Field

The disclosed embodiments relate to user recommendations. More specifically, the disclosed embodiments relate to techniques for performing feedback-based update of candidate recommendations.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for ranking candidate search results. For example, the rankings include rankings of candidates for jobs, positions, roles, and/or other opportunities. The rankings also, or instead, include rankings or recommendations of connections, follows, mentorships, referrals, online dating matches, and/or other types of relationships or interactions for members of an online network. Each ranking can be produced by ordering the candidates by descending score from one or more machine learning models and/or formulas. As a result, candidates at or near the top of a ranking may be deemed to be better qualified for the corresponding opportunity and/or recommendation than candidates that are lower in the ranking.

More specifically, the disclosed embodiments provide a method, apparatus, and system for performing feedback-based recommendation of candidates. In some embodiments, the recommendations are generated with respect to opportunities specified by recruiters or other moderators of the opportunities. For example, a recruiter performs a search by providing a job identifier (ID) for a job. Parameters representing qualifications, requirements, and/or criteria for the job are extracted from a job posting matching the job ID and matched to skills, titles, seniorities, years of experience, industries, locations, and/or other attributes of a set of candidates. The candidates are then ranked by descending score from one or more machine learning models and outputted to the recruiter as results of the search.

When a recruiter provides feedback on candidates recommended for a given job (or other opportunity), the feedback is used to update subsequent ranking or recommendation of candidates for the job. For example, negative feedback by the recruiter on a candidate (e.g., dismissing the candidate, reporting the candidate as not relevant to the job, etc.) results in de-emphasis of one or more attributes of the candidate in the ranking. In another example, positive feedback by the recruiter on a candidate (e.g., saving the candidate, viewing the candidate's profile or resume, contacting the candidate, etc.) results in a greater emphasis on one or more attributes of the candidate in the ranking.

To generate and update a ranking of candidates in response to a search and subsequent feedback by a recruiter, parameters of the search and attributes of the candidates are represented using different sets of scores. For example, parameters of the search include one or more skills listed under qualifications of a job provided by the recruiter in the search. Similarly, attributes of each candidate include one or more skills possessed by the candidate (e.g., based on listing of the skills under the candidate's profile in an online system and/or endorsements of the skills). All possible skills that can be listed under the job and/or candidate profiles are represented as nodes in a graph, with edges between pairs of nodes in the graph representing relationships between the corresponding pairs of skills (e.g., grouping of the skills under a taxonomy of standardized skills, similar jobs, similar candidate profiles, etc.). A score for each skill listed under the job is calculated based on a centrality of the skill in the graph and/or the importance of the skill to the job. Similarly, a score for each skill possessed by a candidate is calculated based on the centrality of the skill in the graph and/or endorsements or other validation of the skill in the candidate.

Next, scores for attributes of the job are combined with corresponding scores for attributes of each candidate to produce overall scores between the candidates and the job. For example, an overall score between a candidate and the job is calculated as a dot product, cosine similarity, Euclidean distance, and/or another measure of vector similarity between a first vector that contains scores for attributes of the job and a second vector that contains score for attributes of the candidate. The candidates are then ranked by descending overall score, and some or all of the ranked candidates are outputted as results of the search. Higher ranked candidates thus include scores for attributes that better match corresponding scores for the attributes as qualifications for the job.

When the recruiter provides positive or negative feedback on one or more of the candidates in the ranking, scores for attributes of the job are updated to reflect the feedback. For example, when the recruiter provides positive feedback on a candidate for the job, scores representing significances of skills (or other attributes) to the job are updated to increase the emphasis of some or all skills possessed by the candidate, including skills that were not originally identified as qualifications for the job. Conversely, when the recruiter provides negative feedback on a candidate for the job, scores for the job's attributes are updated to decrease the emphasis of skills that are common to both the candidate and the job. As a result, scores for the job's attributes are able to reflect the recruiter's explicit feedback on the candidates and, in turn, the recruiter's implicit preferences for “ideal” attributes of the candidates. In turn, real-time or near-real-time updating of the ranking to reflect the new scores (e.g., while the recruiter views and/or interacts with candidates in the ranking) allows candidates that better reflect the recruiter's feedback and/or preferences to be surfaced in the ranking.

By iteratively updating rankings or recommendations of candidates for jobs (or other opportunities) based on feedback from recruiters (or other entities), the disclosed embodiments allow implicit preferences of the recruiters to be reflected in the rankings or recommendations. In turn, the quality or relevance of the candidates to the recruiters is increased, which allows the recruiters to identify qualified or “ideal” candidates more quickly and reduces the amount of searching and/or browsing performed by the recruiters to place the jobs. The reduction in processing associated with the recruiters' searches and/or views additionally improves the utilization of processor, memory, storage, input/output (I/O), and/or other resources by the online system and/or the performance of applications, services, tools, and/or computer systems used to implement the online system. Consequently, the disclosed embodiments may improve computer systems, applications, user experiences, tools, and/or technologies related to generating recommendations, employment, recruiting, and/or hiring.

### Feedback-Based Update of Candidate Recommendations

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) optionally adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

In one or more embodiments, online network 118 includes functionality to improve rankings of candidates 116 outputted as recommendations to recruiters by updating the recommendations based on feedback by the recruiters. As show in FIG. 2, data 202 from data repository 134 is used to generate a ranking 240 of candidates in response to parameters 230 of a search by a recruiter and/or another moderator of opportunities. Data 202 includes profile data 216 for members of an online platform (e.g., online network 118 of FIG. 1), as well as user activity data 218 that tracks the members' and/or candidates' activity within and/or outside the platform.

Profile data 216 includes data associated with member profiles in the platform. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the platform.

Attributes of the members are optionally matched to a number of member segments, with each member segment containing a group of members that share one or more common attributes. For example, member segments in the platform may be defined to include members with the same industry, title, location, and/or language.

Connection information in profile data 216 is optionally combined into a graph, with nodes in the graph representing entities (e.g., users, schools, companies, locations, etc.) in the platform. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the platform. For example, user activity data 218 tracks impressions, clicks, likes, dislikes, shares, hides, comments, posts, updates, conversions, and/or other user interaction with content in the platform. User activity data 218 also, or instead, tracks other types of activity, including connections, messages, job applications, job searches, recruiter searches for candidates, interaction between candidates 116 and recruiters, and/or interaction with groups or events. In some embodiments, user activity data 218 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 additionally includes schedules, calendars, and/or upcoming availabilities of the users, which may be used to schedule meetings, interviews, and/or events for the users. Like profile data 216, user activity data 218 is optionally used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, profile data 216, user activity data 218, and/or other data 202 in data repository 134 is standardized before the data is used by components of the system. For example, skills in profile data 216 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A search apparatus 206 uses data 202 in data repository 134 to identify candidates (e.g., candidates 116 of FIG. 1) that match parameters 230 of a search. For example, search apparatus 206 is provided by a recruiting module or tool that is associated with and/or provided by the platform. Search apparatus 206 includes checkboxes, radio buttons, drop-down menus, text boxes, and/or other user-interface elements that allow a recruiter and/or another moderator involved in hiring for or placing jobs or opportunities to specify parameters 230 related to candidates for an opportunity and/or a number of related opportunities.

Parameters 230 include attributes that are desired or required by an opportunity. For example, parameters 230 include thresholds, values, and/or ranges of values for an industry, location, education, skills, past positions, current positions, seniority, overall qualifications, title, seniority, keywords, awards, publications, patents, licenses and certifications, and/or other attributes or fields associated with profile data 216 for the candidates.

Parameters 230 also, or instead, include identifiers (IDs) for the opportunity and/or ideal candidates for the opportunity. For example, parameters 230 include a job ID for a job for which the recruiter is hiring. After the job ID is submitted by the recruiter in a search, search apparatus 206 retrieves a record matching the job ID from data repository 134 and extracts additional parameters 230 representing desired or required attributes of candidates for the job from the record. In another example, parameters 230 include a member ID for an “ideal” candidate that fits a recruiter's criteria or preferences for a given job. After the member ID is submitted by the recruiter in a search, search apparatus 206 retrieves a record matching the member ID from data repository 134 and extracts additional parameters 230 representing attributes of the candidate from the record.

In some embodiments, search apparatus 206 matches or converts some or all parameters 230 to standardized attributes in data repository 202. For example, search apparatus 206 converts a misspelled, abbreviated, and/or non-standardized company name, title, location, skill, seniority, and/or other word or phrase in parameters 230 into a standardized identifier or value for a corresponding attribute. Search apparatus 206 also, or instead, adds standardized titles, skills, companies, and/or other attributes that are similar to those specified in parameters 230 to an updated set of parameters 230.

Search apparatus 206 and/or another component then queries data repository 134 for profile data 216 that matches some or all parameters 230. In response to the query, data repository 134 returns member identifiers and/or profile data 216 of candidates that match parameters 230. For example, data repository 134 identifies thousands to tens of thousands of candidates with profile attributes that meet or fit one or more parameters 230 and returns some or all of the candidates in a response to the query.

To improve the quality and/or relevance of search results 232 for a given set of search parameters 230, candidates that meet the criteria represented by parameters 230 are ordered in search results 232 based on scores that reflect each candidate's compatibility with parameters 230. More specifically, a scoring apparatus 204 generates a set of job attribute scores 228 for job attributes 220 associated with a job (e.g., as specified in parameters 230 of a search related to the job and/or a posting for the job). Similarly, scoring apparatus 204 generates a set of candidate attribute scores 244 for candidate attributes 222 of each candidate for the job. Such calculation of job attribute scores 228 and/or candidate attribute scores 244 may be performed in an offline, periodic, or batch-processing basis to produce sets of scores for a large number of jobs and/or candidates. Some or all job attribute scores 228 and/or candidate attribute scores 244 may also, or instead, be generated in an online, nearline, and/or on-demand basis based on recent search parameters (e.g., parameters 230) by recruiters and/or other users interacting with search apparatus 206.

In one or more embodiments, job attribute scores 228 represent relative significances of individual job attributes 220 as qualifications for the job, and candidate attribute scores 244 represent confidences in possession of candidate attributes 222 by the corresponding candidates. For example, job attribute scores 228 and candidate attribute scores 244 include values between 0 and 1 for all possible (e.g., standardized) skills in the online system.

In some embodiments, job attribute scores 228 for the job and candidate attribute scores 244 for each candidate are stored in different vectors. Each vector has a length that is equal to the number of skills in the online system, and each element of the vector stores a score for a skill that is represented by the element's position or index in the vector. Scores in each vector are optionally normalized to sum to 1, which allows the scores to represent probabilities of the corresponding attributes. Consequently, the vectors store attributes related to jobs and candidates in a common numeric representation that facilitates comparison of the jobs and candidates.

As shown in FIG. 2, job attribute scores 228 and candidate attribute scores 244 are calculated based on centralities 224-226 of the corresponding job attributes 220 and candidate attributes 222, respectively, in a graph 210. In one or more embodiments, graph 210 includes a set of nodes 212 and a set of edges 214 between pairs of the nodes. Nodes 212 represent job attributes 220, candidate attributes 222, and/or other types of attributes in the online system, and edges 214 between pairs of nodes represent relationships between the corresponding attributes. For example, nodes 212 in graph 210 represent skills (or other attributes) of jobs and/or candidates. An edge between a pair of nodes indicates frequent co-occurrence of the corresponding skills in profile data 216 for the candidates, job postings, courses, certifications, and/or other types of entities or records in the online system. An edge also, or instead, indicates a relationship between the corresponding skills in the hierarchical taxonomy of standardized skills.

In other words, pairs of nodes 212 that are connected by edges 214 and/or shorter paths in graph 210 are more closely related than pairs of nodes 212 that are connected by longer paths in graph 210. In addition, a node with more connections with other nodes in graph 210 is more likely to represent a specific or “important” skill to a given job or candidate, while a node with fewer connections with other nodes in graph 210 is more likely to represent a less specific or “important” skill to the job or candidate.

In some embodiments, scoring apparatus 204 calculates the centrality of each node in graph 210 as a Katz centrality, eigenvector centrality, and/or another measure of the node's connectedness in graph 210. In turn, centralities 224-226 can be used as indicators of the relative significance of the corresponding skills to jobs or candidates.

Scoring apparatus 204 then calculates job attribute scores 228 for a job based on centralities 224 of job attributes 220 found in the job and/or measures of importance 246 of individual job attributes 220 to the job. In some embodiments, each measure of importance 246 is determined based on content in a listing of the job. For example, the listing specifies one or more required skills, one or more preferred skills, and/or one or more desired skills. The required skills are associated with higher importance 246 than the preferred skills, and the preferred skills are associated with higher importance 246 than the desired skills. Scoring apparatus 204 converts importance 246 of a job attribute to a numeric score or weight (e.g., 1.0 for a required skill, 0.7 for a preferred skill, 0.4 for a desired skill, etc.). Scoring apparatus 204 then calculates a score for the attribute as the product of the attribute's centrality in graph 210 and the numeric score or weight representing the importance of the attribute to the job. In general, scoring apparatus 204 calculates each job attribute score using a function that monotonically increases with either the centrality or the importance of the corresponding attribute.

Scoring apparatus 204 also includes functionality to calculate candidate attribute scores 228 for each candidate based on centralities 226 of candidate attributes 222 possessed by the candidate and/or endorsements 248 of the attributes (e.g., from other users of the online system). As with calculation of job attribute scores 228 from centralities 224 and measures of importance 246 of the corresponding job attributes 220, scoring apparatus 204 converts endorsements 248 of a given attribute of a candidate into a numeric score or weight representing the collective level of confidence that the candidate possesses the attribute. For example, scoring apparatus 204 determines a sub-score for each endorsement of an attribute listed in profile data 216 for the candidate. The sub-score represents the strength or legitimacy of the endorsement. Thus, a higher sub-score indicates an endorsement from a user that strongly possesses the same attribute or is in a position to assess the candidate's possession of the attribute, and a lower sub-score indicates an endorsement from a user that does not possess the same attribute or have the ability to assess the candidate's possession of the attribute. Scoring apparatus 204 sums the sub-scores for all endorsements of the attribute into an endorsement score for the attribute. Scoring apparatus 204 then combines the endorsement score with the centrality of the attribute in graph 210 using a function that monotonically increases with either the endorsement score or the centrality.

A ranking apparatus 208 uses job attribute scores 228 for the job and candidate attribute scores 244 for candidates returned in response to parameters 230 related to the job to generate a ranking 240 of the candidates for the job. In one or more embodiments, ranking apparatus 208 combines job attribute scores 228 for the job with candidate attribute scores 244 for each of the candidates to generate a set of overall scores 238 that characterize the compatibility of the candidates with the job. For example, ranking apparatus 208 calculates an overall score between the job and each candidate as a dot product, cosine similarity, Euclidean distance, and/or another measure of vector similarity between a first vector that contains job attribute scores 228 for the job and a second vector that contains candidate attribute scores 244 for the candidate. Ranking apparatus 208 then generates ranking 240 by ordering the candidates by descending overall score.

Search apparatus 206 uses ranking 240 to generate search results 232 that are displayed and/or outputted in response to the corresponding search parameters 230. For example, search apparatus 206 may paginate some or all candidates in ranking 236 into subsets of search results 232 that are displayed as the recruiter scrolls through the search results 232 and/or navigates across screens or pages containing the search results 232.

Search apparatus 206 and/or another component additionally include functionality to output multiple sets of search results 232 based on different rankings of candidates. For example, search apparatus 206 may output, in response to parameters 230 of a search by a recruiter, a first set of search results 232 that includes a “default” ranking of candidates by overall scores 238. Search apparatus 206 may also provide one or more user-interface elements that allow the recruiter to filter candidates in the search results by years of work experience, seniority, location, title, function, industry, level of activity on the platform, and/or other criteria. As a result, the system of FIG. 2 may allow the recruiter to manipulate and/or reorder results 232, depending on the recruiter's preferences and/or objectives with respect to a given opportunity or set of opportunities.

As mentioned above, the system of FIG. 2 includes functionality to update ranking 240 and/or results 232 based on feedback provided by the recruiter on candidates in results 232. More specifically, the feedback includes actions 242 performed by the recruiter on individual candidates in the outputted results 232. Actions 242 include positive and negative reactions of the recruiter to the candidates. For example, actions 242 that represent positive feedback from the recruiter include, but are not limited to, clicking on a candidate in results 232 (e.g., to view the candidate's profile), saving a candidate, contacting the candidate, adding the candidate to a hiring pipeline for the job, interviewing the candidate, and/or hiring the candidate. Actions 242 that represent negative feedback from the recruiter include, but are not limited to, dismissing a candidate in results 232 and/or reporting a candidate as irrelevant to the job (e.g., when a candidate that is an architect is included in results 232 for a software architect job).

In one or more embodiments, positive and negative actions 242 are associated with numeric scores or weights representing the strengths of the actions. For example, contacting a candidate is associated with a higher strength than saving the candidate because contacting the candidate is a more definitively positive reaction than saving the candidate. Similarly, reporting a candidate as irrelevant to a job is associated with a higher strength than dismissing the candidate because identifying the candidate as irrelevant is a more definitively negative reaction than dismissing the candidate.

When the recruiter performs an action on a candidate in results 232, ranking apparatus 208 determines one or more action factors 234 related to the context of the action. Ranking apparatus 208 also calculates a number of score adjustments 236 to job attribute scores 228 for the job based on action factors 234.

More specifically, ranking apparatus 208 converts action factors 234 into one or more numeric values and uses the numeric values to scale job attribute scores 228 for the job and candidate attribute scores 244 for the candidate. Ranking apparatus 208 then combines the scaled job attribute scores 228 and candidate attribute scores 244 into an updated set of job attribute scores 228 that reflect implicit preferences associated with the recruiter's action.

For example, action factors 234 include whether the action is positive or negative, the strength of the action, and/or a timing of the action within the recruiter's search. When the action is positive, ranking apparatus 208 updates job attribute scores 228 using the following equation:

sⱼ(t+1)=α*sⱼ(t)+(1−α)*s_{c}, 0≤α≤1

In the above equation, sⱼ(t) represents a vector of job attribute scores 228 for job j at time t, sⱼ(t+1) represents a vector containing an update to job attribute scores 228 at time t+1, and s_{c} represents a vector of candidate attribute scores 244 for a candidate c to which the action is applied at time t+1. Moreover, α is a value between 0 and 1 that represents a first numerical factor by which job attribute scores 228 are scaled, and 1−α is another value between 0 and 1 that represents a second numerical factor by which candidate attribute scores 244 are scaled. The first and second numerical factors thus represent the proportional contributions of job attribute scores 228 and candidate attribute scores 244 to the updated job attribute scores 228.

Because the updated job attribute scores 228 include positive contributions from candidate attribute scores 244 for the candidate, the updated job attribute scores 228 include positive scores for any attributes possessed by the candidate that were not included in the qualifications for the job. Thus, as the recruiter continues to provide positive feedback on candidates, job attribute scores 228 are updated to reflect attributes of the candidates that are implicitly favored by the recruiter.

In addition, α is selected to reflect action factors 234 associated with the action. When the action is performed early in the recruiter's search (e.g., when the recruiter is trying to narrow or fine-tune the search) and/or associated with a higher strength, a is set to a relatively lower value to increase the contribution of candidate attribute scores 244 for the candidate associated with the action to the updated job attribute scores 228. When the action is performed later in the recruiter's search and/or associated with a lower strength, α may be set to a relatively higher value to reduce the impact of candidate attribute scores 244 for the candidate on the updated job attribute scores 228.

Continuing with the above example, when the action is negative, ranking apparatus 208 updates job attribute scores 228 using the following equation:

sⱼ(t+1)=β*sⱼ(t)−(β−1)*s_{c}, β≥1, sⱼ(t+1)≥0

In the above equation, β is a value greater than or equal to 1 (e.g., between 1 and 2) that represents a first numerical factor by which job attribute scores 228 are scaled, and β−1 is a positive value that represents a second numerical factor by which candidate attribute scores 244 for the candidate are scaled. A negative action by the recruiter on the candidate thus causes job attribute scores 228 for qualifications of the job that the candidate lacks to increase and job attribute scores 228 for qualifications of the job that the candidate possesses to potentially decrease. At the same time, enforcing a minimum value of 0 for the updated job attribute scores 228 prevents job attribute scores 228 for attributes found in the candidate but not in the job from becoming negative. After the scaled candidate attribute scores 244 are subtracted from the scaled job attribute scores 228, the resulting updated job attribute scores 228 are renormalized so that the scores sum to 1.

As with the selection of α and/or 1−α in adjusting job attribute scores 228 based on positive feedback by the recruiter, β and β−1 are selected to reflect action factors 234 associated with the action. When the action is performed early in the recruiter's search and/or associated with a higher strength, β can be set to a relatively higher value to increase the effect of the action on the updated job attribute scores 228. When the action is performed later in the recruiter's search and/or associated with a lower strength, β can be set to a relatively lower value to decrease the impact of the action on the updated job attribute scores 228.

After job attribute scores 228 are updated to reflect a recent action from the recruiter, search apparatus 206 optionally queries data repository 134 for a new set of candidates that match job attribute scores 228. Next, ranking apparatus 208 recalculates overall scores 238 between the updated job attribute scores 228 and candidate attribute scores 244 of the candidates and updates ranking 240 to reflect the new overall scores 238. Search apparatus 206 then outputs the updated ranking 240 in results 232 in real-time or near-real-time to allow the recruiter to interact with the updated ranking 240 within the same search and/or session. As the recruiter performs additional actions 242 on the outputted results 232, ranking apparatus 208 applies corresponding score adjustments 236 to job attribute scores 228, recalculates overall scores 228 to reflect the updated job attribute scores 228, and generates ranking 240 according to the new overall scores 228. Search apparatus 206 additionally updates the outputted results 232 to reflect the new ranking 240. Consequently, the system of FIG. 2 updates results 232 after the recruiter performs one or more actions 242 on candidates in results 232 to reflect implicit preferences represented by actions 242.

Ranking apparatus 208, search apparatus 206, and/or another component optionally store the latest set of job attribute scores 228 in data repository 134 and/or another data store after the recruiter ends the session. When the recruiter resumes the search in a subsequent session, the stored job attribute scores 228 are retrieved and used to generate ranking 240 and/or results 232. Updates to job attribute scores 228, overall scores 238, and ranking 240 are also made based on the recruiter's actions 242 on results 232, thereby allowing the search to be tailored to the recruiter's behavior or preferences across multiple sessions.

By iteratively updating rankings 240, search results 232, and/or recommendations of candidates for jobs (or other opportunities) based on feedback from recruiters (or other entities), the system of FIG. 2 allows implicit preferences of the recruiters to be reflected in the rankings, search results, or recommendations. In turn, the quality or relevance of the candidates to the recruiters is increased, which allows the recruiters to identify qualified or “ideal” candidates more quickly and reduces the amount of searching and/or browsing performed by the recruiters to place the jobs. The reduction in processing associated with the recruiters' searches and/or views additionally improves the utilization of processor, memory, storage, input/output (I/O), and/or other resources by the online system and/or the performance of applications, services, tools, and/or computer systems used to implement the online system. Consequently, the disclosed embodiments may improve computer systems, applications, user experiences, tools, and/or technologies related to generating recommendations, employment, recruiting, and/or hiring.

Those skilled in the art will appreciate that the system of FIG. 2 may be implemented in a variety of ways. First, scoring apparatus 204, ranking apparatus 208, search apparatus 206, and/or data repository 134 may be provided by a single physical machine, multiple computer systems, one or more virtual machines, a grid, one or more databases, one or more filesystems, and/or a cloud computing system. Scoring apparatus 204, ranking apparatus 208, and search apparatus 206 may additionally be implemented together and/or separately by one or more hardware and/or software components and/or layers.

Second, a number of techniques may be used to generate graph 210, job attribute scores 228, candidate attribute scores 244, overall scores 238, and/or score adjustments 236. For example, edges 214 between nodes 212 in graph 210 may be created based on similarities between embeddings and/or other semantic representations of attributes represented by nodes 212. In another example, job attribute scores 228 and/or candidate attribute scores 244 may be calculated based on a term frequency-inverse document frequency (tf-idf) and/or other measures of uniqueness or importance of the attributes in one or more sets of documents or records representing candidates and/or jobs. In a third example, numeric values of action factors 234 and/or score adjustments 236 are selected by a machine learning model that is trained to produce a final or “ideal” set of job attribute scores 228 for a number of jobs (e.g., based on ratings of the importance of the attributes to the jobs by recruiters involved in placing the jobs), given a series of actions applied to candidates for each of the jobs by the recruiters. In a fourth example, different types of equations and/or formulas may be used to determine score adjustments 236 and/or apply score adjustments 236 to job attribute scores 228.

Third, the system of FIG. 2 may be adapted to generate and/or update search results 232 or recommendations for various types of searches and/or entities. For example, the functionality of the system may be used to improve and/or personalize search results 232 or recommendations containing candidates for academic positions, artistic or musical roles, school admissions, fellowships, scholarships, competitions, club or group memberships, matchmaking, and/or other types of opportunities.

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a first set of scores representing significances of a set of attributes as qualifications for an opportunity are obtained based on parameters of a search of an online system by an entity (operation 302). For example, a subset of the attributes (e.g., skills, titles, seniorities, years of experience, industries, etc.) is obtained as qualifications for a job based on an identifier for the job provided in the search parameters by a recruiter (e.g., by retrieving the subset of attributes from a job posting matching the identifier). A graph containing nodes representing the set of attributes and edges representing relationships between pairs of the nodes is also retrieved, and the first set of scores is calculated based on centralities of the subset of attributes in the graph and/or the importance of each of the attributes to the job (e.g., a score or weight that indicates if an attribute is required, preferred, or desired in candidates for the job).

Next, additional sets of scores representing confidences in possession of the set of attributes by the candidates are determined (operation 304). For example, a candidate is deemed to possess an attribute (e.g., a skill) when the candidate lists the attribute in his/her member profile with the online system and/or receives endorsements of the attribute by other members of the online system. A score representing the confidence in the candidate possessing the skill is calculated by combining the centrality of the skill in the graph with an endorsement score that reflects the number of endorsements of the attribute and/or the strengths of the endorsements.

A ranking of candidates for the opportunity is generated based on the first set of scores and the additional sets of scores (operation 306), and the ranking is outputted as results of the search in a user interface of the online system during a session with the entity (operation 308). For example, the first set of scores is combined with an additional set of scores for each candidate into an overall score for the candidate, and the candidates are ranked by descending overall score. The ranking is then displayed in one or more pages of search results to the entity.

The first set of scores is updated based on one or more actions by the entity on one or more candidates in the outputted ranking and one or more additional sets of scores associated with the candidate(s) (operation 310). For example, the first set of scores is scaled by a first factor, and an additional set of scores for a candidate associated with an action by the entity is scaled by a second factor. The scaled first set of scores is then combined with the scaled additional set of scores into the updated first set of scores.

In some embodiments, the first and second factors are selected based on a classification of the action as positive or negative, a strength of the action, and/or a timing of the action within the search. When the action indicates negative feedback by the entity on the candidate, the updated first set of scores is determined by subtracting the scaled additional set of scores from the scaled first set of scores and enforcing a minimum score of zero in the updated first set of scores. When the action indicates positive feedback by the entity on the candidate, the updated first set of scores is determined by summing the scaled additional set of scores and the scaled first set of scores.

Finally, the outputted ranking of candidates is updated in the user interface of the online system based on the updated first set of scores and the additional sets of scores (operation 312). For example, the updated first set of scores for the opportunity is combined with an additional set of scores for each candidate into a new overall score for the candidate, and the candidates are re-ranked by the new overall scores in the user interface during the same session with the entity and/or a subsequent session between the entity and online system. The re-ranked candidates thus reflect implicit preferences associated with the entity's actions on the search results.

Operations 310-312 may be repeated during updating of recommendations (operation 314) for the entity. For example, the first set of scores and ranking may continue to be updated as the entity interacts with candidates in the ranking over one or more sessions.

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes a scoring apparatus, a ranking apparatus, and a search apparatus, one or more of which may alternatively be termed or implemented as a module, mechanism, or other type of system component. The scoring apparatus obtains, based on parameters of a search of an online system by an entity, a first set of scores representing significances of a set of attributes as qualifications for an opportunity. The scoring apparatus also obtains additional sets of scores representing confidences in possession of the set of attributes by the candidates. Next, the ranking apparatus generates a ranking of candidates for the opportunity based on the first set of scores and the additional sets of scores, and the search apparatus outputs the ranking as results of the search. The ranking apparatus then updates the first set of scores based on one or more actions by the entity on one or more candidates in the outputted ranking and one or more additional sets of scores associated with the candidate(s). Finally, the search apparatus updates the outputted ranking based on the updated first set of scores and the additional sets of scores.

In addition, one or more components of computer system 400 may be remotely located and connected to the other components over a network. Portions of the present embodiments (e.g., ranking apparatus, scoring apparatus, search apparatus, data repository, online network, etc.) may also be located on different nodes of a distributed system that implements the embodiments. For example, the present embodiments may be implemented using a cloud computing system that generates candidate search results for searches performed by a set of remote recruiting entities.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, based on parameters of a search of an online system by an entity, a first set of scores representing significances of a set of attributes as qualifications for an opportunity;
generating, by one or more computer systems, a ranking of candidates for the opportunity based on the first set of scores and additional sets of scores representing confidences in possession of the set of attributes by the candidates;
during a session with the entity, outputting the ranking as results of the search in a user interface of the online system;
updating, by the one or more computer systems, the first set of scores based on one or more actions by the entity on one or more of the candidates in the outputted ranking and one or more of the additional sets of scores associated with the one or more of the candidates; and
updating, by the one or more computer systems during the session with the entity, the outputted ranking of the candidates in the user interface of the online system based on the updated first set of scores and the additional sets of scores.

2. The method of claim 1, further comprising:
determining the additional sets of scores for the candidates.

3. The method of claim 2, wherein determining the additional sets of scores for the candidates comprises:
obtaining a graph comprising nodes representing the set of attributes and edges representing relationships between pairs of the nodes; and
for each candidate in the candidates, calculating an additional set of scores representing the confidences in the possession of the set of attributes by the candidate based on a subset of the attributes possessed by the candidate and centralities of the subset of the attributes in the graph.

4. The method of claim 3, wherein determining the additional sets of scores for the candidates further comprises:
calculating the additional set of scores based on endorsements of the subset of the attributes possessed by the candidate by other users of the online system.

5. The method of claim 4, wherein calculating the additional set of scores based on the endorsements of the subset of the attributes possessed by the candidate by the other users of the online system comprises:
calculating an endorsement score for an attribute possessed by the candidate based on a number of endorsements of the attribute by the other users and strengths of the endorsements; and
combining the endorsement score with a centrality of the attribute in the graph into a score representing a confidence in possession of the attribute by the candidate.

6. The method of claim 1, wherein obtaining the first set of scores representing the significances of the set of attributes as qualifications of the opportunity comprises:
obtaining a subset of the attributes identified as qualifications for the opportunity based on an identifier for the opportunity provided in the parameters;
obtaining a graph comprising nodes representing the set of attributes and edges representing relationships between pairs of the nodes; and
calculating the first set of scores based on centralities of the subset of attributes in the graph.

7. The method of claim 1, wherein generating the ranking of the candidates for the opportunity based on the first set of scores and the additional sets of scores representing the confidences in possession of the set of attributes by the candidates comprises:
for each candidate in the candidates, combining the first set of scores with an additional set of scores representing the confidences in the possession of the set of attributes by the candidate into an overall score for the candidate; and
ranking the candidates by the overall score.

8. The method of claim 1, wherein updating the first set of scores based on the one or more actions by the entity on the one or more of the candidates in the outputted ranking and the one or more of the additional sets of scores associated with the one or more of the candidates comprises:
scaling the first set of scores by a first factor;
scaling an additional set of scores for a candidate associated with an action by the entity by a second factor; and
combining the scaled first set of scores and the scaled additional set of scores into the updated first set of scores.

9. The method of claim 8, wherein updating the first set of scores based on the one or more actions by the entity on the one or more of the candidates in the outputted ranking and the one or more of the additional sets of scores associated with the one or more of the candidates further comprises:
selecting the first and second factors based on at least one of a classification of the action as positive or negative, a strength of the action, and a timing of the action within the search.

10. The method of claim 8, wherein combining the scaled first set of scores and the scaled additional set of scores into the updated first set of scores comprises:
when the action indicates negative feedback by the entity on the candidate, determining the updated first set of scores by subtracting the scaled additional set of scores from the scaled first set of scores; and
enforcing a minimum score of zero in the updated first set of scores.

11. The method of claim 8, wherein combining the scaled first set of scores and the scaled additional set of scores into the updated first set of scores comprises:
when the action indicates positive feedback by the entity on the candidate, determining the updated first set of scores by summing the scaled additional set of scores and the scaled first set of scores.

12. The method of claim 1, wherein the set of attributes comprise a set of skills.

13. A system, comprising:
one or more processors; and
memory storing instructions that, when executed by the one or more processors, cause the system to:
obtain, based on a search of an online system by an entity for candidates for an opportunity, a first set of scores representing significances of a set of attributes as qualifications for the opportunity;
generate a ranking of candidates for the opportunity based on the first set of scores and additional sets of scores representing confidences in possession of the set of attributes by the candidates;
during a session with the entity, output the ranking as results of the search in a user interface of the online system;
update the first set of scores based on one or more actions by the entity on one or more of the candidates in the outputted ranking and one or more of the additional sets of scores associated with the one or more of the candidates; and
during the session with the entity, update the outputted ranking of the candidates in the user interface of the online system based on the updated first set of scores and the additional sets of scores.

14. The system of claim 13, wherein the memory further stores instructions that, when executed by the one or more processors, cause the system to:
determine the additional sets of scores for the candidates.

15. The system of claim 14, wherein determining the additional sets of scores for the candidates comprises:
obtaining a graph comprising nodes representing the set of attributes and edges representing relationships between pairs of the nodes; and
for each candidate in the candidates, calculating an additional set of scores representing the confidences in the possession of the set of attributes by the candidate based on a subset of the attributes possessed by the candidate, centralities of the subset of the attributes in the graph, and endorsements of the subset of the attributes possessed by the candidate by other users of the online system.

16. The system of claim 13, wherein generating the ranking of the candidates for the opportunity based on the first set of scores and the additional sets of scores representing the confidences in possession of the set of attributes by the candidates comprises:
for each candidate in the candidates, combining the first set of scores with an additional set of scores representing the confidences in the possession of the set of attributes by the candidate into an overall score for the candidate; and
ranking the candidates by the overall score.

17. The system of claim 13, wherein updating the first set of scores based on the one or more actions by the entity on the one or more of the candidates in the outputted ranking and the one or more of the additional sets of scores associated with the one or more of the candidates comprises:
scaling the first set of scores by a first factor;
scaling an additional set of scores for a candidate associated with an action by the entity by a second factor; and
combining the scaled first set of scores and the scaled additional set of scores into the updated first set of scores.

18. The system of claim 17, wherein combining the scaled first set of scores and the scaled additional set of scores into the updated first set of scores comprises:
when the action indicates negative feedback by the entity on the candidate, determining the updated first set of scores by subtracting the scaled additional set of scores from the scaled first set of scores; and
enforcing a minimum score of zero in the updated first set of scores.

19. The system of claim 17, wherein combining the scaled first set of scores and the scaled additional set of scores into the updated first set of scores comprises:
when the action indicates positive feedback by the entity on the candidate, determining the updated first set of scores by summing the scaled additional set of scores and the scaled first set of scores.

20. A non-transitory computer-readable storage medium storing instructions that when executed by a computer cause the computer to perform a method, the method comprising:
obtaining, based on parameters of a search of an online system by an entity, a first set of scores representing significances of a set of attributes as qualifications for an opportunity;
generating a ranking of candidates for the opportunity based on the first set of scores and additional sets of scores representing confidences in possession of the set of attributes by the candidates;
during a session with the entity, outputting the ranking as results of the search in a user interface of the online system;
updating the first set of scores based on one or more actions by the entity on one or more of the candidates in the outputted ranking and one or more of the additional sets of scores associated with the one or more of the candidates; and
during the session with the entity, updating the outputted ranking of the candidates in the user interface of the online system based on the updated first set of scores and the additional sets of scores.
